(19) United States
(12) Patent Application Publication
(10) Pub. No.: US 2017/0289653 A1
(43) Pub. Date: Oct. 5, 2017

(54) OPTICAL SWITCHING UNIT AND OPTICAL SWITCHING DEVICE

(71) Applicants: SUMITOMO ELECTRIC INDUSTRIES, LTD., Osaka-shi (JP); SEI Optifrontier Co., Ltd., Yokohama-shi (JP)

(72) Inventors: Tetsufumi TSUZAKI, Kanagawa (JP); Yoshinobu SUZUKI, Kanagawa (JP); Junichi OTA, Kanagawa (JP)

(73) Assignees: SUMITOMO ELECTRIC INDUSTRIES, LTD., Osaka-shi (JP); SEI Optifrontier Co., Ltd., Yokohama-shi (JP)

(21) Appl. No.: 15/454,057

(22) Filed: Mar. 9, 2017

(30) Foreign Application Priority Data
Mar. 30, 2016 (JP) 2016-068474

(51) Int. Cl. H04Q 11/00; G02B 6/44; G02B 6/38

(52) U.S. Cl. CPC H04Q 11/0005; G02B 6/3897; G02B 6/3895; G02B 6/4452; H04Q 2011/0035

(57) ABSTRACT

An optical switching unit includes first to twelfth adapters and a panel portion. The panel portion has first to fourth regions. The first and second regions and the third and fourth regions are provided along the first direction, respectively, and the first and third regions and the second and fourth regions are provided along a second direction orthogonal to the first direction, respectively. In the first region, the first to third adapters are disposed along a first direction. The second adapter is located between the first and third adapters and a distance between the first and second adapters is longer than a distance between the second and third adapters. An engagement portion of the second adapter is provided at the side of the first adapter and an engagement portion of the third adapter is provided at the side opposite to the side of the second adapter.

### TECHNICAL FIELD

The present invention relates to an optical switching unit and an optical switching device.

### BACKGROUND

Conventionally, an optical switching device to switch a transmission path of an optical signal is known. In the optical switching device, it is required to mount adapters used for an input or an output of the optical signal at a high density.

For example, Japanese Utility Model Registration No. 3124365 describes a splitter panel in which a plurality of LC adapters are arranged at a high density on a front surface of an optical patch panel.

### SUMMARY

However, when the adapters are arranged at a small interval for high-density mounting, a worker may not sufficiently secure a space to insert and extract a connector. For this reason, workability when the connector is inserted into the adapter or is extracted from the adapter may be degraded. As the adapters used for the optical switching device, there are an input adapter to input an optical signal and an output adapter to output an optical signal. However, when the adapters are arranged at the small interval as described above, it may be difficult to identify which adapter has a function of the input adapter and which adapter has a function of the output adapter.

The present invention provides an optical switching unit and an optical switching device capable of improving workability of insertion and extraction of a connector and identification of a function of each adapter while realizing high-density mounting.

An optical switching unit according to an aspect of the present invention includes first to twelfth adapters configured to enable insertion and extraction of connectors; a first optical switch configured to switch optical connection of the first and second adapters and optical connection of the first and third adapters; a second optical switch configured to switch optical connection of the fourth and fifth adapters and optical connection of the fourth and sixth adapters; a third optical switch configured to switch optical connection of the seventh and eighth adapters and optical connection of the seventh and ninth adapters; a fourth optical switch configured to switch optical connection of the tenth and eleventh adapters and optical connection of the tenth and twelfth adapters; and a panel portion configured to dispose the first to twelfth adapters. Each of the first to twelfth adapters has an insertion hole into which the connector is inserted and an engagement portion which is provided in a peripheral edge of the insertion hole and engages with a latch for insertion and extraction in the connector. The panel portion has a first region where the first to third adapters are disposed along a first direction, a second region where the fourth to sixth adapters are disposed along the first direction, a third region where the seventh to ninth adapters are disposed along the first direction, and a fourth region where the tenth to twelfth adapters are disposed along the first direction. The first and second regions and the third and fourth regions are provided along the first direction, respectively, and the first and third regions and the second and fourth regions are provided along a second direction orthogonal to the first direction, respectively. The second adapter is located between the first and third adapters, a distance between the first and second adapters is longer than a distance between the second and third adapters, the engagement portion of the second adapter is provided at the side of the first adapter, and the engagement portion of the third adapter is provided at the side opposite to the side of the second adapter. The fifth adapter is located between the fourth and sixth adapters, a distance between the fourth and fifth adapters is longer than a distance between the fifth and sixth adapters, the engagement portion of the fifth adapter is provided at the side of the fourth adapter, and the engagement portion of the sixth adapter is provided at the side opposite to the side of the fifth adapter. The eighth adapter is located between the seventh and ninth adapters, a distance between the seventh and eighth adapters is longer than a distance between the eighth and ninth adapters, the engagement portion of the eighth adapter is provided at the side of the seventh adapter, and the engagement portion of the ninth adapter is provided at the side opposite to the side of the eighth adapter. The eleventh adapter is located between the tenth and twelfth adapters, a distance between the tenth and eleventh adapters is longer than a distance between the eleventh and twelfth adapters, the engagement portion of the eleventh adapter is provided at the side of the tenth adapter, and the engagement portion of the twelfth adapter is provided at the side opposite to the side of the eleventh adapter.

An optical switching device according to another aspect of the present invention includes the optical switching unit and a frame configured to mount one or more optical switching units.

According to the present invention, an optical switching unit and an optical switching device capable of improving workability of insertion and extraction of a connector and identification of a function of each adapter while realizing high-density mounting can be provided.

### BRIEF DESCRIPTION OF THE DRAWINGS

FIG. 1 is a schematic diagram illustrating an optical switching device according to an embodiment of the present invention;

FIG. 2 is a schematic diagram illustrating an optical switching unit illustrated in FIG. 1; and

FIG. 3 is a schematic diagram illustrating an internal structure of the optical switching unit illustrated in FIG. 2.

### DETAILED DESCRIPTION

### Description of Embodiment of Present Invention

First, contents of an embodiment of the present invention will be described.

An optical switching unit according to an aspect of the present invention includes first to twelfth adapters configured to enable insertion and extraction of connectors; a first optical switch configured to switch optical connection of the first and second adapters and optical connection of the first and third adapters; a second optical switch configured to switch optical connection of the fourth and fifth adapters and optical connection of the fourth and sixth adapters; a third optical switch configured to switch optical connection of the seventh and eighth adapters and optical connection of the seventh and ninth adapters; a fourth optical switch configured to switch optical connection of the tenth and eleventh adapters and optical connection of the tenth and twelfth adapters; and a panel portion configured to dispose the first to twelfth adapters. Each of the first to twelfth adapters has an insertion hole into which the connector is inserted and an engagement portion which is provided in a peripheral edge of the insertion hole and engages with a latch for insertion and extraction in the connector. The panel portion has a first region where the first to third adapters are disposed along a first direction, a second region where the fourth to sixth adapters are disposed along the first direction, a third region where the seventh to ninth adapters are disposed along the first direction, and a fourth region where the tenth to twelfth adapters are disposed along the first direction. The first and second regions and the third and fourth regions are provided along the first direction, respectively, and the first and third regions and the second and fourth regions are provided along a second direction orthogonal to the first direction, respectively. The second adapter is located between the first and third adapters, a distance between the first and second adapters is longer than a distance between the second and third adapters, the engagement portion of the second adapter is provided at the side of the first adapter, and the engagement portion of the third adapter is provided at the side opposite to the side of the second adapter. The fifth adapter is located between the fourth and sixth adapters, a distance between the fourth and fifth adapters is longer than a distance between the fifth and sixth adapters, the engagement portion of the fifth adapter is provided at the side of the fourth adapter, and the engagement portion of the sixth adapter is provided at the side opposite to the side of the fifth adapter. The eighth adapter is located between the seventh and ninth adapters, a distance between the seventh and eighth adapters is longer than a distance between the eighth and ninth adapters, the engagement portion of the eighth adapter is provided at the side of the seventh adapter, and the engagement portion of the ninth adapter is provided at the side opposite to the side of the eighth adapter. The eleventh adapter is located between the tenth and twelfth adapters, a distance between the tenth and eleventh adapters is longer than a distance between the eleventh and twelfth adapters, the engagement portion of the eleventh adapter is provided at the side of the tenth adapter, and the engagement portion of the twelfth adapter is provided at the side opposite to the side of the eleventh adapter.

In the optical switching unit according to the aspect of the present invention, in each region of the panel portion, the adapters are disposed such that a distance between the two adapters having different functions is longer than a distance between the two adapters having the same function. As such, the adapters are disposed collectively for each function, so that a worker can easily identify the function of each adapter. In addition, in each region, the collectively disposed two adapters are disposed such that directions where the engagement portions are provided in the individual adapters are opposite to each other. The adapters are disposed in these directions, so that a space to operate the latch of the connector is formed at a position adjacent to each adapter in the first direction. Therefore, workability of insertion and extraction of the connector for each adapter can be improved. As a result, workability of insertion and extraction of the connector and identification of a function of each adapter can be improved while high-density mounting is realized.

The first and seventh adapters, the second and eighth adapters, the third and ninth adapters, the fourth and tenth adapters, the fifth and eleventh adapters, and the sixth and twelfth adapters may be integrated, respectively. In this case, an interval of the two adapters to be integrated can be eliminated. The first and seventh adapters, the second and eighth adapters, the third and ninth adapters, the fourth and tenth adapters, the fifth and eleventh adapters, and the sixth and twelfth adapters are disposed along the second direction, respectively. Therefore, the adapters can be disposed at a high density in the second direction.

The first to third adapters may be disposed toward the second region in this order. The fourth to sixth adapters may be disposed to be separated from the first region in this order. The seventh to ninth adapters may be disposed toward the fourth region in this order. The tenth to twelfth adapters may be disposed to be separated from the third region in this order. In this case, the fourth, seventh, and tenth adapters having the same function as the function of the first adapter are disposed at positions corresponding to a position where the first adapter is disposed in the first region, in the individual regions (second to fourth regions). In addition, the fifth, eighth, and eleventh adapters having the same function as the function of the second adapter are disposed at positions corresponding to a position where the second adapter is disposed in the first region, in the individual regions (second to fourth regions). In addition, the sixth, ninth, and twelfth adapters having the same function as the function of the third adapter are disposed at positions corresponding to a position where the third adapter is disposed in the first region, in the individual regions (second to fourth regions). Therefore, identification of the function of each adapter can be further improved.

The engagement portion of the first adapter may be provided at the side opposite to the side of the second adapter, the engagement portion of the fourth adapter may be provided at the side opposite to the side of the fifth adapter, the engagement portion of the seventh adapter may be provided at the side opposite to the side of the eighth adapter, and the engagement portion of the tenth adapter may be provided at the side opposite to the side of the eleventh adapter. In this case, because the engagement portion of the first adapter and the engagement portion of the second adapter do not face each other, a space to operate the latch of the connector with respect to the first adapter and a space to operate the latch of the connector with respect to the second adapter are formed at different positions, respectively. Likewise, spaces to operate the latches of the connectors with respect to the fourth and fifth adapters, the seventh and eighth adapters, and the tenth and eleventh adapters are formed at different positions, respectively. Therefore, workability of insertion and extraction of the connectors with respect to these adapters can be further improved.

The optical switching unit according to the aspect may further include a first operation unit configured to be disposed in the first region; a second operation unit configured to be disposed in the second region; a third operation unit configured to be disposed in the third region; and a fourth operation unit configured to be disposed in the fourth region. When the first operation unit is operated, the first optical switch may switch optical connection of the first and second adapters and optical connection of the first and third adapters. When the second operation unit is operated, the second optical switch may switch optical connection of the fourth and fifth adapters and optical connection of the fourth and sixth adapters. When the third operation unit is operated, the third optical switch may switch optical connection of the seventh and eighth adapters and optical connection of the seventh and ninth adapters. When the fourth operation unit is operated, the fourth optical switch may switch optical connection of the tenth and eleventh adapters and optical connection of the tenth and twelfth adapters. In this case, an adapter optically connected to the first adapter can be switched by operating the first operation unit, an adapter optically connected to the fourth adapter can be switched by operating the second operation unit, an adapter optically connected to the seventh adapter can be switched by operating the third operation unit, and an adapter optically connected to the tenth adapter can be switched by operating the fourth operation unit. In addition, because each of the operation units is disposed in the same region as the adapter switched by operating each operation unit, a worker can easily recognize a correspondence relation of the operation unit and the adapter and switching work can be improved.

The first operation unit may be disposed closer to the side of the second region than the first to third adapters, the second operation unit may be disposed closer to the side of the first region than the fourth to sixth adapters, the third operation unit may be disposed closer to the side of the fourth region than the seventh to ninth adapters, and the fourth operation unit may be disposed closer to the side of the third region than the tenth to twelfth adapters. In this case, because the first and second operation units are disposed between the adapter disposed closest to the side of the second region among the adapters disposed in the first region and the adapter disposed closest to the side of the first region among the adapters disposed in the second region, a distance between these adapters increases. For this reason, spaces to operate the latches of the connectors with respect to these adapters can be expanded. Likewise, a distance between the adapter disposed closest to the side of the fourth region among the adapters disposed in the third region and the adapter disposed closest to the side of the third region among the adapters disposed in the fourth region increases and spaces to operate the latches of the connectors with respect to these adapters can be expanded. Therefore, workability of insertion and extraction of the connectors with respect to these adapters can be further improved.

The optical switching unit according to the aspect may further include a first display configured to show an adapter optically connected to the first adapter in the first optical switch, in the second and third adapters; a second display configured to show an adapter optically connected to the fourth adapter in the second optical switch, in the fifth and sixth adapters; a third display configured to show an adapter optically connected to the seventh adapter in the third optical switch, in the eighth and ninth adapters; and a fourth display configured to show an adapter optically connected to the tenth adapter in the fourth optical switch, in the eleventh and twelfth adapters. The first display may be disposed in the first region, the second display may be disposed in the second region, the third display may be disposed in the third region, and the fourth display may be disposed in the fourth region. In this case, the adapter optically connected to the first adapter can be identified by the first display, the adapter optically connected to the fourth adapter can be identified by the second display, the adapter optically connected to the seventh adapter can be identified by the third display, and the adapter optically connected to the tenth adapter can be identified by the fourth display. In addition, because each display is disposed in the same region as the adapter shown by each display, identification of the adapters that can input or output optical signals can be improved.

The first display may be disposed closer to the side of the second region than the first to third adapters, the second display may be disposed closer to the side of the first region than the fourth to sixth adapters, the third display may be disposed closer to the side of the fourth region than the seventh to ninth adapters, and the fourth display may be disposed closer to the side of the third region than the tenth to twelfth adapters. In this case, because the first and second displays are disposed between the adapter disposed closest to the side of the second region among the adapters disposed in the first region and the adapter disposed closest to the side of the first region among the adapters disposed in the second region, a distance between these adapters increases. For this reason, spaces to operate the latches of the connectors with respect to these adapters can be expanded. Likewise, a distance between the adapter disposed closest to the side of the fourth region among the adapters disposed in the third region and the adapter disposed closest to the side of the third region among the adapters disposed in the fourth region increases and spaces to operate the latches of the connectors with respect to these adapters can be expanded. Therefore, workability of insertion and extraction of the connectors with respect to these adapters can be further improved.

The optical switching unit according to the aspect may further include a first light reception element configured to detect strength of an optical signal input to or output from the second adapter; a second light reception element configured to detect strength of an optical signal input to or output from the third adapter; a third light reception element configured to detect strength of an optical signal input to or output from the fifth adapter; a fourth light reception element configured to detect strength of an optical signal input to or output from the sixth adapter; a fifth light reception element configured to detect strength of an optical signal input to or output from the eighth adapter; a sixth light reception element configured to detect strength of an optical signal input to or output from the ninth adapter; a seventh light reception element configured to detect strength of an optical signal input to or output from the eleventh adapter; and an eighth light reception element configured to detect strength of an optical signal input to or output from the twelfth adapter. In this case, the strength of the optical signal input to or output from the adapter switched in each optical switch is detected. Therefore, abnormality of the optical signal can be detected.

The first to twelfth adapters may be adapters for LC connectors. In this case, it is possible to improve workability of insertion and extraction of the LC connectors and identification of a function of each of the adapters for the LC connectors while realizing high-density mounting using the adapters for the LC connectors.

An optical switching device according to another aspect of the present invention includes the optical switching unit and a frame configured to mount one or more optical switching units.

Because the above-described optical switching unit is mounted in the optical switching device, workability of insertion and extraction of a connector and identification of a function of each adapter can be improved while high-density mounting is realized.

### Details of Embodiment of Present Invention

Specific examples of an optical switching unit and an optical switching device according to the embodiment of the present invention will be described hereinafter with reference to the drawings. However, it is intended that the present invention is not limited to the exemplary embodiment and all changes within the scope of the appended claims and their equivalents are included in the present invention.

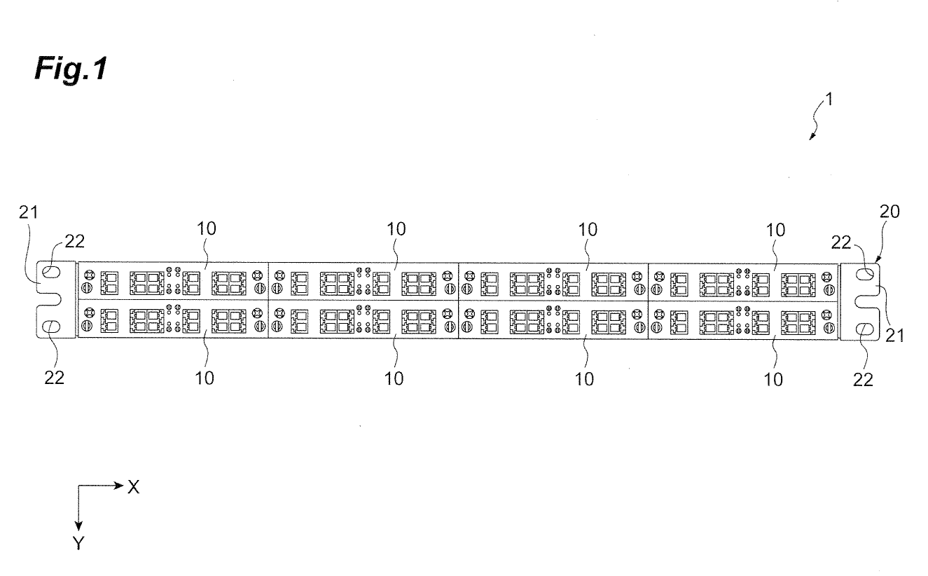

FIG. 1 is a schematic diagram illustrating the optical switching device according to the embodiment of the present invention. An optical switching device 1 illustrated in FIG. 1 is a device to switch a transmission path of an optical signal. For example, the optical switching device 1 is used to switch the transmission path into other transmission path when a failure occurs in the transmission path, thereby causing the transmission path to be redundant. The optical switching device 1 includes 8 optical switching units 10 and a frame 20 on which the optical switching units 10 are mounted.

The frame 20 is a casing on which a maximum of 8 optical switching units 10 can be mounted. The frame 20 has almost a rectangular parallelepiped shape and can mount 4 optical switching units 10 on an upper step thereof and mount 4 optical switching units 10 on a lower step thereof. The frame 20 has slots (not illustrated in the drawings) that enable the optical switching units 10 to be attached or detached. The frame 20 has flange portions 21 that are provided in both ends in an X-axis direction (first direction) thereof. Holes 22 to attach the optical switching device 1 to a 19-inch rack of an EIA standard are provided in the flange portions 21. In addition, the frame 20 is designed to be attached to a space of a 1 U size (a height of 44.45 mm) of the 19-inch rack. The number of optical switching units 10 mounted on the frame 20 is not limited to 8. For example, the optical switching device 1 may be used in a state in which 7 optical switching units 10 are mounted on the frame 20. In addition, the optical switching units 10 may be increased or decreased in the middle of using the optical switching device 1. In addition, a dimension of the frame 20 is not limited to the above dimension and may be arbitrarily determined.

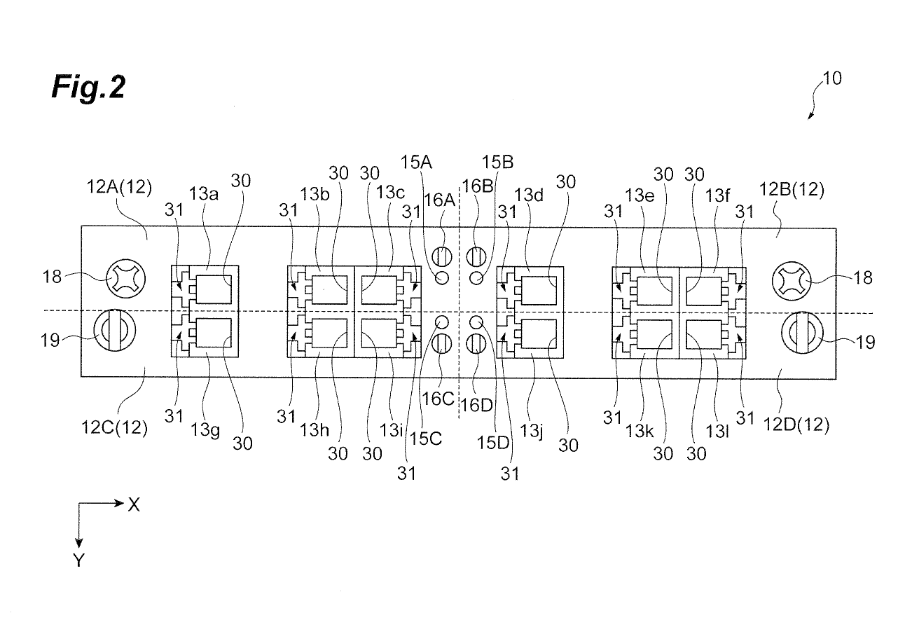

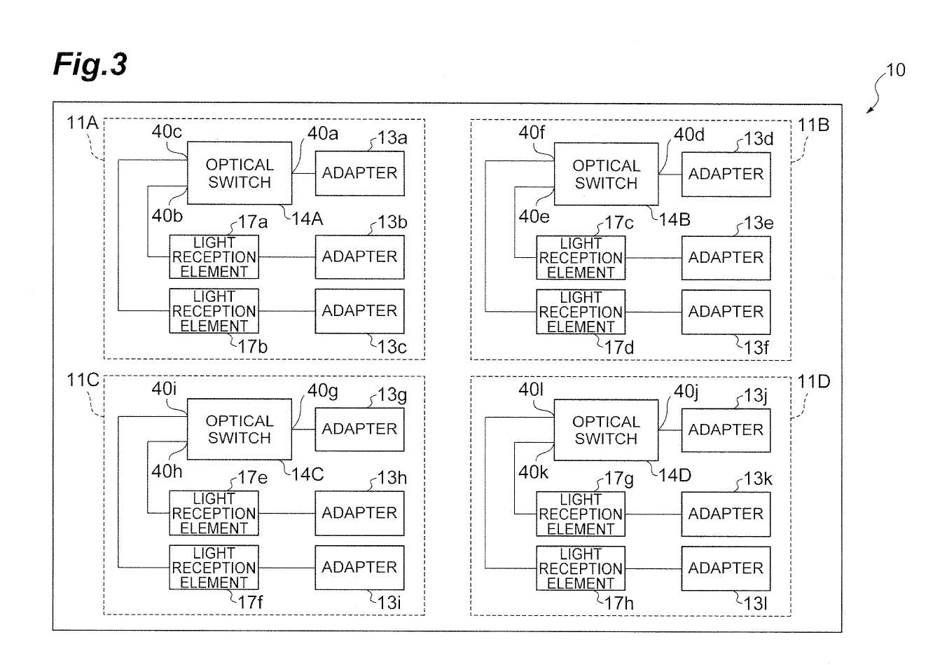

Next, the optical switching unit 10 will be described in detail with reference to FIGS. 2 and 3. FIG. 2 is a schematic diagram illustrating the optical switching unit 10. FIG. 3 is a schematic diagram illustrating an internal structure of the optical switching unit 10. The optical switching unit 10 includes switching blocks 11A, 11B, 11C, and 11D and a panel portion 12. Each of the switching blocks 11A to 11D has three adapters and performs switching of a transmission path of two inputs and one output or one input and two outputs. In this embodiment, the case in which each of the switching blocks 11A to 11D performs switching of the transmission path of one input and two outputs will be described as an example. The switching blocks 11A to 11D are functionally separated. However, the switching blocks 11A to 11D may be physically mounted on one substrate.

The switching block 11A has an adapter 13a (first adapter), an adapter 13b (second adapter), an adapter 13c (third adapter), an optical switch 14A (first optical switch), an operation unit 15A (first operation unit), a display 16A (first display), a light reception element 17a (first light reception element), and a light reception element 17b (second light reception element). Each of the adapters 13a to 13c has an insertion hole 30 into which a connector is inserted and an engagement portion 31 which engages with a latch for insertion and extraction in the connector. The engagement portion 31 is provided in a peripheral edge of the insertion hole 30. The engagement portion 31 and the latch for the insertion and extraction in the connector engage with each other, so that the connector is fixed on each of the adapters 13a to 13c. In addition, engagement of the engagement portion 31 and the latch for the insertion and the extraction is released by operating the latch for the insertion and the extraction, so that the connector can be removed from each of the adapters 13a to 13c. Each of the adapters 13a to 13e is an adapter for an LC connector which the LC connector can be inserted into or can be extracted from. The adapter 13a is an adapter used for an input of an optical signal and the adapters 13b and 13c are adapters used for an output of an optical signal.

The optical switch 14A has ports 40a to 40c. The port 40a and the adapter 13a, the port 40b and the adapter 13b, and the port 40c and the adapter 13c are optically connected, respectively. The operation unit 15A is used when switching of the transmission path is performed. The operation unit 15A is a button, for example. The operation unit 15A is operated, so that the optical switch 14A switches optical connection of the ports 40a and 40b and optical connection of the ports 40a and 40c. That is, the optical switch 14A alternately switches optical connection of the adapters 13a and 13b and optical connection of the adapters 13a and 13c, whenever the operation unit 15A is operated. As such, an optical signal input to the adapter 13a is output from one adapter selected by the optical switch 14A in the adapters 13b and 13c.

The display 16A displays an adapter optically connected to the adapter 13a in the adapters 13b and 13c. The display 16A is a light emitting diode (LED), for example, and shows the adapter optically connected to the adapter 13a, by a color of the LED, a lighting state of the LED, or the like.

The light reception element 17a is provided between the adapter 13b and the port 40b (refer to FIG. 3) and detects strength of an optical signal output from the adapter 13b. For example, the light reception element 17a detects the strength of the optical signal by detecting strength of monitor light branched from the optical signal by an optical coupler (not illustrated in the drawings) provided between the adapter 13b and the port 40b. The light reception element 17b is provided between the adapter 13c and the port 40c (refer to FIG. 3) and detects strength of an optical signal output from the adapter 13c. For example, the light reception element 17b detects the strength of the optical signal by detecting strength of monitor light branched from the optical signal by an optical coupler (not illustrated in the drawings) provided between the adapter 13c and the port 40c. The light reception elements 17a and 17b are photodiodes, for example. The strengths of the optical signals detected by the light reception elements 17a and 17b can be used to determine the adapter optically connected to the adapter 13a in the adapters 13b and 13c in the optical switch 14A.

The switching block 11B has an adapter 13d (fourth adapter), an adapter 13e (fifth adapter), an adapter 13f (sixth adapter), an optical switch 14B (second optical switch), an operation unit 15B (second operation unit), a display 16B (second display), a light reception element 17c (third light reception element), and a light reception element 17d (fourth light reception element). Each of the adapters 13d to 13f has an insertion hole 30 into which a connector is inserted and an engagement portion 31 which engages with a latch for insertion and extraction in the connector. The engagement portion 31 is provided in a peripheral edge of the insertion hole 30. The engagement portion 31 and the latch for the insertion and extraction in the connector engage with each other, so that the connector is fixed on each of the adapters 13d to 13f. In addition, engagement of the engagement portion 31 and the latch for the insertion and the extraction is released by operating the latch for the insertion and the extraction, so that the connector can be removed from each of the adapters 13d to 13f. Each of the adapters 13d to 13f is an adapter for an LC connector which the LC connector can be inserted into or can be extracted from. The adapter 13d is an adapter used for an input of an optical signal and the adapters 13e and 13f are adapters used for an output of an optical signal.

The optical switch 14B has ports 40d to 40f. The port 40d and the adapter 13d, the port 40e and the adapter 13e, and the port 40f and the adapter 13f are optically connected, respectively. The operation unit 15B is used when switching of the transmission path is performed.

The operation unit 15B is a button, for example. The operation unit 15B is operated, so that the optical switch 14B switches optical connection of the ports 40d and 40e and optical connection of the ports 40d and 40f. That is, the optical switch 14B alternately switches optical connection of the adapters 13d and 13e and optical connection of the adapters 13d and 13f, whenever the operation unit 15B is operated. As such, an optical signal input to the adapter 13d is output from one adapter selected by the optical switch 14B in the adapters 13e and 13f.

The display 16B displays an adapter optically connected to the adapter 13d in the adapters 13e and 13f. The display 16B is a LED, for example, and shows the adapter optically connected to the adapter 13d, by a color of the LED, a lighting state of the LED, or the like.

The light reception element 17c is provided between the adapter 13e and the port 40e (refer to FIG. 3) and detects strength of an optical signal output from the adapter 13e. For example, the light reception element 17c detects the strength of the optical signal by detecting strength of monitor light branched from the optical signal by an optical coupler (not illustrated in the drawings) provided between the adapter 13e and the port 40e. The light reception element 17d is provided between the adapter 13f and the port 40f (refer to FIG. 3) and detects strength of an optical signal output from the adapter 13f. For example, the light reception element 17d detects the strength of the optical signal by detecting strength of monitor light branched from the optical signal by an optical coupler (not illustrated in the drawings) provided between the adapter 13f and the port 40f. The light reception elements 17c and 17d are photodiodes, for example. The strengths of the optical signals detected by the light reception elements 17c and 17d can be used to determine the adapter optically connected to the adapter 13d in the adapters 13e and 13f in the optical switch 14B.

The switching block 11C has an adapter 13g (seventh adapter), an adapter 13h (eighth adapter), an adapter 13i (ninth adapter), an optical switch 14C (third optical switch), an operation unit 15C (third operation unit), a display 16C (third display), a light reception element 17e (fifth light reception element), and a light reception element 17f (sixth light reception element). Each of the adapters 13g to 13i has an insertion hole 30 into which a connector is inserted and an engagement portion 31 which engages with a latch for insertion and extraction in the connector. The engagement portion 31 is provided in a peripheral edge of the insertion hole 30. The engagement portion 31 and the latch for the insertion and extraction in the connector engage with each other, so that the connector is fixed on each of the adapters 13g to 13i. In addition, engagement of the engagement portion 31 and the latch for the insertion and the extraction is released by operating the latch for the insertion and the extraction, so that the connector can be removed from each of the adapters 13g to 13i. Each of the adapters 13g to 13i is an adapter for an LC connector which the LC connector can be inserted into or can be extracted from. The adapter 13g is an adapter used for an input of an optical signal and the adapters 13h and 13i are adapters used for an output of an optical signal.

The optical switch 14C has ports 40g to 40i. The port 40g and the adapter 13g, the port 40h and the adapter 13h, and the port 40i and the adapter 13i are optically connected, respectively. The operation unit 15C is used when switching of the transmission path is performed. The operation unit 15C is a button, for example. The operation unit 15C is operated, so that the optical switch 14C switches optical connection of the ports 40g and 40h and optical connection of the ports 40g and 40i. That is, the optical switch 14C alternately switches optical connection of the adapters 13g and 13h and optical connection of the adapters 13g and 13i, whenever the operation unit 15C is operated. As such, an optical signal input to the adapter 13g is output from one adapter selected by the optical switch 14C in the adapters 13h and 13i.

The display 16C displays an adapter optically connected to the adapter 13g in the adapters 13h and 13i. The display 16C is a LED, for example, and shows the adapter optically connected to the adapter 13g, by a color of the LED, a lighting state of the LED, or the like.

The light reception element 17e is provided between the adapter 13h and the port 40h (refer to FIG. 3) and detects strength of an optical signal output from the adapter 13h. For example, the light reception element 17e detects the strength of the optical signal by detecting strength of monitor light branched from the optical signal by an optical coupler (not illustrated in the drawings) provided between the adapter 13h and the port 40h. The light reception element 17f is provided between the adapter 13i and the port 40i (refer to FIG. 3) and detects strength of an optical signal output from the adapter 13i. For example, the light reception element 17f detects the strength of the optical signal by detecting strength of monitor light branched from the optical signal by an optical coupler (not illustrated in the drawings) provided between the adapter 13i and the port 40i. The light reception elements 17e and 17f are photodiodes, for example. The strengths of the optical signals detected by the light reception elements 17e and 17f can be used to determine the adapter optically connected to the adapter 13g in the adapters 13h and 13i in the optical switch 14C.

The switching block 11D has an adapter 13j (tenth adapter), an adapter 13k (eleventh adapter), an adapter 13l (twelfth adapter), an optical switch 14D (fourth optical switch), an operation unit 15D (fourth operation unit), a display 16D (fourth display), a light reception element 17g (seventh light reception element), and a light reception element 17h (eighth light reception element). Each of the adapters 13j to 13l has an insertion hole 30 into which a connector is inserted and an engagement portion 31 which engages with a latch for insertion and extraction in the connector. The engagement portion 31 is provided in a peripheral edge of the insertion hole 30. The engagement portion 31 and the latch for the insertion and extraction in the connector engage with each other, so that the connector is fixed on each of the adapters 13j to 13l. In addition, engagement of the engagement portion 31 and the latch for the insertion and the extraction is released by operating the latch for the insertion and the extraction, so that the connector can be removed from each of the adapters 13j to 13l. Each of the adapters 13j to 13l is an adapter for an LC connector which the LC connector can be inserted into or can be extracted from. The adapter 13j is an adapter used for an input of an optical signal and the adapters 13k and 13l are adapters used for an output of an optical signal.

The optical switch 14D has ports 40j to 40l. The port 40j and the adapter 13j, the port 40k and the adapter 13k, and the port 40l and the adapter 13l are optically connected, respectively. The operation unit 15D is used when switching of the transmission path is performed. The operation unit 15D is a button, for example. The operation unit 15D is operated, so that the optical switch 14D switches optical connection of the ports 40j and 40k and optical connection of the ports 40j and 40l. That is, the optical switch 14D alternately switches optical connection of the adapters 13j and 13k and optical connection of the adapters 13j and 13l, whenever the operation unit 15D is operated. As such, an optical signal input to the adapter 13j is output from one adapter selected by the optical switch 14D in the adapters 13k and 13l.

The display 16D displays an adapter optically connected to the adapter 13j in the adapters 13k and 13l. The display 16D is a LED, for example, and shows the adapter optically connected to the adapter 13j, by a color of the LED, a lighting state of the LED, or the like.

The light reception element 17g is provided between the adapter 13k and the port 40k (refer to FIG. 3) and detects strength of an optical signal output from the adapter 13k. For example, the light reception element 17g detects the strength of the optical signal by detecting strength of monitor light branched from the optical signal by an optical coupler (not illustrated in the drawings) provided between the adapter 13k and the port 40k. The light reception element 17h is provided between the adapter 13l and the port 40l (refer to FIG. 3) and detects strength of an optical signal output from the adapter 13l. For example, the light reception element 17h detects the strength of the optical signal by detecting strength of monitor light branched from the optical signal by an optical coupler (not illustrated in the drawings) provided between the adapter 13l and the port 40l. The light reception elements 17g and 17h are photodiodes, for example. The strengths of the optical signals detected by the light reception elements 17g and 17h can be used to determine the adapter optically connected to the adapter 13j in the adapters 13k and 13l in the optical switch 14D.

Next, the panel portion 12 of the optical switching unit 10 will be described. The panel portion 12 is a plate-like member to connect an optical fiber and is also called a patch panel. The panel portion 12 has a rectangular shape extending in the X-axis direction. The adapters 13a to 13l, the operation units 15A to 15D, and the displays 16A to 16D are arranged in the panel portion 12. The panel portion 12 has four regions of a region 12A (first region), a region 12B (second region), a region 12C (third region), and a region 12D (fourth region). The regions 12A and 12B and the regions 12C and 12D are provided along the X-axis direction (longitudinal direction of the panel portion 12), respectively. In addition, the regions 12A and 12C and the regions 12B and 12D are provided along a Y-axis direction (second direction) orthogonal to the X-axis direction, respectively.

The adapter 13a, the adapter 13b, the adapter 13c, the operation unit 15A, and the display 16A are disposed in the region 12A. The adapters 13a to 13c are disposed along the X-axis direction toward the region 12B in this order. In addition, the adapters 13a to 13c are disposed such that the adapter 13b is located between the adapters 13a and 13c and a distance between the adapters 13a and 13b is longer than a distance between the adapters 13b and 13c. In other words, the adapters 13a to 13c are disposed collectively for each function for an output or an input. In the region 12A illustrated in FIG. 2, the adapters 13a to 13c are disposed such that the adapter 13a used for the input of the optical signal is separated from the adapters 13b and 13c used for the output of the optical signal and the adapters 13b and 13c contact each other.

The adapter 13a is disposed such that the engagement portion 31 of the adapter 13a is located at the side (a direction separated from the adapter 13b) opposite to the side of the adapter 13b in the X-axis direction. The adapter 13b is disposed such that the engagement portion 31 of the adapter 13b is located at the side (a direction toward the adapter 13a) of the adapter 13a in the X-axis direction. The adapter 13c is disposed such that the engagement portion 31 of the adapter 13c is located at the side (the direction separated from the adapter 13b) opposite to the side of the adapter 13b in the X-axis direction. In other words, in the adapters 13a and 13b, the engagement portion 31 is located in an X-axis negative direction with respect to the insertion hole 30 and in the adapter 13c, the engagement portion 31 is located in an X-axis positive direction with respect to the insertion hole 30. That is, a direction where the engagement portion 31 is provided in the adapter 13a and a direction where the engagement portion 31 is provided in the adapter 13b are the same. In addition, a direction where the engagement portion 31 is provided in the adapter 13b and a direction where the engagement portion 31 is provided in the adapter 13c are opposite to each other in the X-axis direction. In the region 12A illustrated in FIG. 2, the adapters 13a, 13b, and 13c are disposed toward the region 12B (in the X-axis positive direction) in this order. However, the adapters 13a, 13b, and 13c may be disposed to be separated from the region 12B (in the X-axis negative direction) in this order.

The operation unit 15A and the display 16A are disposed closer to the side of the region 12B than the adapters 13a, 13b, and 13c. In addition, the operation unit 15A is disposed closer to the side of the region 12C than the display 16A. A position relation of the operation unit 15A and the display 16A in the Y-axis direction is not limited to the above arrangement. For example, the display 16A may be disposed closer to the side of the region 12C than the operation unit 15A.

The adapter 13d, the adapter 13e, the adapter 13f, the operation unit 15B, and the display 16B are disposed in the region 12B. The adapters 13d to 13f are disposed along the X-axis direction to be separated from the region 12A in this order. In addition, the adapters 13d to 13f are disposed such that the adapter 13e is located between the adapters 13d and 13f and a distance between the adapters 13d and 13e is longer than a distance between the adapters 13e and 13f. In other words, the adapters 13d to 13f are disposed collectively for each function for an output or an input. In the region 12B illustrated in FIG. 2, the adapters 13d to 13f are disposed such that the adapter 13d used for the input of the optical signal is separated from the adapters 13e and 13f used for the output of the optical signal and the adapters 13e and 13f contact each other.

The adapter 13d is disposed such that the engagement portion 31 of the adapter 13d is located at the side (a direction separated from the adapter 13e) opposite to the side of the adapter 13e in the X-axis direction. The adapter 13e is disposed such that the engagement portion 31 of the adapter 13e is located at the side (a direction toward the adapter 13d) of the adapter 13d in the X-axis direction. The adapter 13f is disposed such that the engagement portion 31 of the adapter 13f is located at the side (the direction separated from the adapter 13e) opposite to the side of the adapter 13e in the X-axis direction. In other words, in the adapters 13d and 13e, the engagement portion 31 is located in an X-axis negative direction with respect to the insertion hole 30 and in the adapter 13f, the engagement portion 31 is located in an X-axis positive direction with respect to the insertion hole 30. That is, a direction where the engagement portion 31 is provided in the adapter 13d and a direction where the engagement portion 31 is provided in the adapter 13e are the same. In addition, a direction where the engagement portion 31 is provided in the adapter 13e and a direction where the engagement portion 31 is provided in the adapter 13f are opposite to each other in the X-axis direction. In the region 12B illustrated in FIG. 2, the adapters 13d, 13e, and 13f are disposed to be separated from the region 12A (in the X-axis positive direction) in this order. However, the adapters 13d, 13e, and 13f may be disposed toward the region 12A (in the X-axis negative direction) in this order.

The operation unit 15B and the display 16B are disposed closer to the side of the region 12A than the adapters 13d, 13e, and 13f. In addition, the operation unit 15B is disposed closer to the side of the region 12D than the display 16B. A position relation of the operation unit 15B and the display 16B in the Y-axis direction is not limited to the above arrangement. For example, the display 16B may be disposed closer to the side of the region 12D than the operation unit 15B.

The adapter 13g, the adapter 13h, the adapter 13l, the operation unit 15C, and the display 16C are disposed in the region 12C. The adapters 13g to 13i are disposed along the X-axis direction toward the region 12D in this order. In addition, the adapters 13g to 13l are disposed such that the adapter 13h is located between the adapters 13g and 13i and a distance between the adapters 13g and 13h is longer than a distance between the adapters 13h and 13i. In other words, the adapters 13g to 13i are disposed collectively for each function for an output or an input. In the region 12C illustrated in FIG. 2, the adapters 13g to 13i are disposed such that the adapter 13g used for the input of the optical signal is separated from the adapters 13h and 13i used for the output of the optical signal and the adapters 13h and 13i contact each other.

The adapter 13g is disposed such that the engagement portion 31 of the adapter 13g is located at the side (a direction separated from the adapter 13h) opposite to the side of the adapter 13h in the X-axis direction. The adapter 13h is disposed such that the engagement portion 31 of the adapter 13h is located at the side (a direction toward the adapter 13g) of the adapter 13g in the X-axis direction. The adapter 13i is disposed such that the engagement portion 31 of the adapter 13i is located at the side (the direction separated from the adapter 13h) opposite to the side of the adapter 13h in the X-axis direction. In other words, in the adapters 13g and 13h, the engagement portion 31 is located in an X-axis negative direction with respect to the insertion hole 30 and in the adapter 13i, the engagement portion 31 is located in an X-axis positive direction with respect to the insertion hole 30. That is, a direction where the engagement portion 31 is provided in the adapter 13g and a direction where the engagement portion 31 is provided in the adapter 13h are the same. In addition, a direction where the engagement portion 31 is provided in the adapter 13h and a direction where the engagement portion 31 is provided in the adapter 13i are opposite to each other in the X-axis direction. In the region 12C illustrated in FIG. 2, the adapters 13g, 13h, and 13i are disposed toward the region 12D (in the X-axis positive direction) in this order. However, the adapters 13g, 13h, and 13i may be disposed to be separated from the region 12D (in the X-axis negative direction) in this order.

The operation unit 15C and the display 16C are disposed closer to the side of the region 12D than the adapters 13g, 13h, and 13i. In addition, the operation unit 15C is disposed closer to the side of the region 12A than the display 16C. A position relation of the operation unit 15C and the display 16C in the Y-axis direction is not limited to the above arrangement. For example, the display 16C may be disposed closer to the side of the region 12A than the operation unit 15C.

The adapter 13j, the adapter 13k, the adapter 13l, the operation unit 15D, and the display 16D are disposed in the region 12D. The adapters 13j to 13l are disposed along the X-axis direction to be separated from the region 12C in this order. In addition, the adapters 13j to 13l are disposed such that the adapter 13k is located between the adapters 13j and 13l and a distance between the adapters 13j and 13k is longer than a distance between the adapters 13k and 13l. In other words, the adapters 13j to 13l are disposed collectively for each function for an output or an input. In the region 12D illustrated in FIG. 2, the adapters 13j to 13l are disposed such that the adapter 13j used for the input of the optical signal is separated from the adapters 13k and 13l used for the output of the optical signal and the adapters 13k and 13l contact each other.

The adapter 13j is disposed such that the engagement portion 31 of the adapter 13j is located at the side (a direction separated from the adapter 13k) opposite to the side of the adapter 13k in the X-axis direction. The adapter 13k is disposed such that the engagement portion 31 of the adapter 13k is located at the side (a direction toward the adapter 13j) of the adapter 13j in the X-axis direction. The adapter 13l is disposed such that the engagement portion 31 of the adapter 13l is located at the side (the direction separated from the adapter 13k) opposite to the side of the adapter 13k in the X-axis direction. In other words, in the adapters 13j and 13k, the engagement portion 31 is located in an X-axis negative direction with respect to the insertion hole 30 and in the adapter 13l, the engagement portion 31 is located in an X-axis positive direction with respect to the insertion hole 30. That is, a direction where the engagement portion 31 is provided in the adapter 13j and a direction where the engagement portion 31 is provided in the adapter 13k are the same. In addition, a direction where the engagement portion 31 is provided in the adapter 13k and a direction where the engagement portion 31 is provided in the adapter 13l are opposite to each other in the X-axis direction. In the region 12D illustrated in FIG. 2, the adapters 13j, 13k, and 13l are disposed to be separated from the region 12C (in the X-axis positive direction) in this order. However, the adapters 13j, 13k, and 13l may be disposed toward the region 12C (in the X-axis negative direction) in this order.

The operation unit 15D and the display 16D are disposed closer to the side of the region 12C than the adapters 13j, 13k, and 13l. In addition, the operation unit 15D is disposed closer to the side of the region 12B than the display 16D. A position relation of the operation unit 15D and the display 16D in the Y-axis direction is not limited to the above arrangement. For example, the display 16D may be disposed closer to the side of the region 12B than the operation unit 15D.

The adapters 13a and 13g, the adapters 13b and 13h, the adapters 13c and 13i, the adapters 13d and 13j, the adapters 13e and 13k, and the adapters 13f and 13l are disposed to contact each other in the Y-axis direction, respectively, and are integrated. As an example of an integrated adapter, an adapter for a duplex LC connector is used.

In addition, a screw 18 to fix the substrate on which the switching blocks 11A to 11D are mounted on the panel portion 12 and a screw 19 to fix the optical switching unit 10 to the frame 20 are provided in the panel portion 12. The screws 18 and 19 are provided in both ends of the panel portion 12 in the X-axis direction. Positions of the screws 18 and 19 are not limited to the above positions and the screws 18 and 19 may be provided at any positions of the panel portion 12 that do not interfere with the adapters 13a to 13l, the operation units 15A to 15D, and the displays 16A to 16D.

As described above, in the optical switching device 1 and the optical switching unit 10, in each region of the panel portion 12, the adapters are disposed such that a distance between the two adapters having different functions is longer than a distance between the two adapters having the same function. As such, the adapters are disposed collectively for each function, so that a worker can easily identify the function of each adapter. In addition, in each region, the collectively disposed two adapters (the adapters 13b and 13c, the adapters 13e and 13f, the adapters 13h and 13i, and the adapters 13k and 13l) are disposed such that directions where the engagement portions 31 are provided in the individual adapters are opposite to each other. The adapters are disposed in these directions, so that a space to operate a latch of the LC connector is formed at a position adjacent to each adapter in the X-axis direction. Therefore, workability of insertion and extraction of the LC connector for each adapter can be improved.

In the optical switching unit 10, the adapters 13a to 13c are disposed toward the region 12B in this order. The adapters 13d to 13f are disposed to be separated from the region 12A in this order. The adapters 13g to 13i are disposed toward the region 12D in this order. The adapters 13j to 13l are disposed to be separated from the region 12C in this order. As such, the adapters 13d, 13g, and 13j having the same function as the function of the adapter 13a are disposed at positions corresponding to a position where the adapter 13a is disposed in the region 12A, in the individual regions (regions 12B to 12D). In addition, the adapters 13e, 13h, and 13k having the same function as the function of the adapter 13b are disposed at positions corresponding to a position where the adapter 13b is disposed in the region 12A, in the individual regions (regions 12B to 12D). In addition, the adapters 13f, 13i, and 13l having the same function as the function of the adapter 13c are disposed at positions corresponding to a position where the adapter 13c is disposed in the region 12A, in the individual regions (regions 12B to 12D). That is, the adapters to which the optical signals are input and the adapters from which the optical signals are output are disposed in the same order in the individual regions 12A to 12D. Therefore, identification of the function of each adapter can be further improved.

The engagement portion 31 of the adapter 13a is provided in a direction opposite to the adapter 13b with respect to the insertion hole 30. For this reason, because the engagement portion 31 of the adapter 13a and the engagement portion 31 of the adapter 13b do not face each other, a space to operate a latch of a connector with respect to the adapter 13a and a space to operate a latch of a connector with respect to the adapter 13b are formed at different positions, respectively. This is the same in the adapters 13d, 13g, and 13j. Therefore, workability of insertion and extraction of the connectors with respect to these adapters can be further improved.

The adapters 13a and 13g, the adapters 13b and 13h, the adapters 13c and 13i, the adapters 13d and 13j, the adapters 13e and 13k, and the adapters 13f and 13l are integrated, respectively. As a result, an interval of the two adapters to be integrated can be eliminated. In addition, the adapters 13a and 13g, the adapters 13b and 13h, the adapters 13c and 13i, the adapters 13d and 13j, the adapters 13e and 13k, and the adapters 13f and 13l are disposed along the Y-axis direction, respectively. Therefore, the adapters can be disposed at a high density, in the Y-axis direction.

In the optical switching unit 10, the adapter optically connected to the adapter 13a can be switched by operating the operation unit 15A. The adapter optically connected to the adapter 13d can be switched by operating the operation unit 15B. The adapter optically connected to the adapter 13g can be switched by operating the operation unit 15C. The adapter optically connected to the adapter 13j can be switched by operating the operation unit 15D. Because each of the operation units 15A to 15D is disposed in the same region as the adapter switched by operating each operation unit, the worker can easily recognize a correspondence relation of the operation unit and the adapter and switching work can be improved.

The operation unit 15A is disposed closer to the side of the region 12B than the adapters 13a to 13c. The operation unit 15B is disposed closer to the side of the region 12A than the adapters 13d to 13f. The operation unit 15C is disposed closer to the side of the region 12D than the adapters 13g to 13i. The operation unit 15D is disposed closer to the side of the region 12C than the adapters 13j to 13l. As a result, because the operation units 15A and 15B are disposed between the adapters 13c and 13d, a distance between these adapters 13c and 13d increases. For this reason, even though the engagement portion 31 of the adapter 13c and the engagement portion 31 of the adapter 13d face each other, the space to operate the latch of the connector with respect to the adapter can be expanded. Therefore, workability of insertion and extraction of the connectors with respect to these adapters can be further improved. Likewise, a distance between the adapters 13i and 13j increases and the space to operate the latch of the connector with respect to the adapter can be expanded. Therefore, even though the engagement portion 31 of the adapter 13i and the engagement portion 31 of the adapter 13j face each other, workability of insertion and extraction of the connectors with respect to these adapters can be further improved.

In the optical switching unit 10, the adapter optically connected to the adapter 13a can be identified by the display 16A. The adapter optically connected to the adapter 13d can be identified by the display 16B. The adapter optically connected to the adapter 13g can be identified by the display 16C. The adapter optically connected to the adapter 13j can be identified by the display 16D. Because each of the displays 16A to 16D is disposed in the same region as the adapter displayed by each display, identification of the adapters that can input or output the optical signal can be improved.

The display 16A is disposed closer to the side of the region 12B than the adapters 13a to 13c. The display 16B is disposed closer to the side of the region 12A than the adapters 13d to 13f. The display 16C is disposed closer to the side of the region 12D than the adapters 13g to 13i. The display 16D is disposed closer to the side of the region 12C than the adapters 13j to 13l. As a result, because the displays 16A and 16B are disposed between the adapters 13c and 13d, a distance between these adapters 13c and 13d increases. For this reason, even though the engagement portion 31 of the adapter 13c and the engagement portion 31 of the adapter 13d face each other, the space to operate the latch of the connector with respect to the adapter can be expanded. Therefore, workability of insertion and extraction of the connectors with respect to these adapters can be further improved. Likewise, a distance between the adapters 13i and 13j increases and the space to operate the latch of the connector with respect to the adapter can be expanded. Therefore, even though the engagement portion 31 of the adapter 13i and the engagement portion 31 of the adapter 13j face each other, workability of insertion and extraction of the connectors with respect to these adapters can be further improved.

In the optical switching unit 10, the strengths of the optical signals output from the adapters switched in the optical switches 14A to 14D are detected by the light reception elements 17a to 17h. For this reason, abnormality of the optical signals can be detected. In addition, the optical switch 14A is controlled such that the adapter in which the strength of the optical signal is high is selected in the adapters 13b and 13c, on the basis of the strengths of the optical signals detected by the light reception elements 17a and 17b. As a result, the optical signal having the higher strength can be output. The optical switches 14B to 14D can be controlled in the same way as the optical switch 14A.

The optical switching unit and the optical switching device according to the present invention are not limited to the embodiment. For example, the adapters 13a and 13g, the adapters 13b and 13h, the adapters 13c and 13i, the adapters 13d and 13j, the adapters 13e and 13k, and the adapters 13f and 13l may not be integrated in the Y-axis direction, respectively. In addition, the adapters 13b and 13c, the adapters 13e and 13f, the adapters 13h and 13i, and the adapters 13k and 13l may be separated from each other, respectively.

If the worker does not need to operate the optical switches 14A to 14D directly, the optical switching unit 10 may not include the operation units 15A to 15D. In addition, the optical switching unit 10 may not include the displays 16A to 16D.

In addition, the adapters 13a to 13l are not limited to the adapters for the LC connectors and are selected appropriately according to types of connectors connected to the adapters 13a to 13l.

What is claimed is:

1. An optical switching unit comprising:
first to twelfth adapters configured to enable insertion and extraction of connectors;
a first optical switch configured to switch optical connection of the first and second adapters and optical connection of the first and third adapters;
a second optical switch configured to switch optical connection of the fourth and fifth adapters and optical connection of the fourth and sixth adapters;
a third optical switch configured to switch optical connection of the seventh and eighth adapters and optical connection of the seventh and ninth adapters;
a fourth optical switch configured to switch optical connection of the tenth and eleventh adapters and optical connection of the tenth and twelfth adapters; and
a panel portion configured to dispose the first to twelfth adapters,
wherein each of the first to twelfth adapters has an insertion hole into which the connector is inserted and an engagement portion which is provided in a peripheral edge of the insertion hole and engages with a latch for insertion and extraction in the connector,
the panel portion has a first region where the first to third adapters are disposed along a first direction, a second region where the fourth to sixth adapters are disposed along the first direction, a third region where the seventh to ninth adapters are disposed along the first direction, and a fourth region where the tenth to twelfth adapters are disposed along the first direction,
the first and second regions and the third and fourth regions are provided along the first direction, respectively,
the first and third regions and the second and fourth regions are provided along a second direction orthogonal to the first direction, respectively,
the second adapter is located between the first and third adapters,
a distance between the first and second adapters is longer than a distance between the second and third adapters,
the engagement portion of the second adapter is provided at the side of the first adapter,
the engagement portion of the third adapter is provided at the side opposite to the side of the second adapter,
the fifth adapter is located between the fourth and sixth adapters,
a distance between the fourth and fifth adapters is longer than a distance between the fifth and sixth adapters,
the engagement portion of the fifth adapter is provided at the side of the fourth adapter,
the engagement portion of the sixth adapter is provided at the side opposite to the side of the fifth adapter,
the eighth adapter is located between the seventh and ninth adapters,
a distance between the seventh and eighth adapters is longer than a distance between the eighth and ninth adapters,
the engagement portion of the eighth adapter is provided at the side of the seventh adapter,
the engagement portion of the ninth adapter is provided at the side opposite to the side of the eighth adapter,
the eleventh adapter is located between the tenth and twelfth adapters,
a distance between the tenth and eleventh adapters is longer than a distance between the eleventh and twelfth adapters,
the engagement portion of the eleventh adapter is provided at the side of the tenth adapter, and
the engagement portion of the twelfth adapter is provided at the side opposite to the side of the eleventh adapter.

2. The optical switching unit according to claim 1, wherein
the first and seventh adapters, the second and eighth adapters, the third and ninth adapters, the fourth and tenth adapters, the fifth and eleventh adapters, and the sixth and twelfth adapters are integrated, respectively.

3. The optical switching unit according to claim 1, wherein
the first to third adapters are disposed toward the second region in this order,
the fourth to sixth adapters are disposed to be separated from the first region in this order,
the seventh to ninth adapters are disposed toward the fourth region in this order, and
the tenth to twelfth adapters are disposed to be separated from the third region in this order.

4. The optical switching unit according to claim 1, wherein
the engagement portion of the first adapter is provided at the side opposite to the side of the second adapter,
the engagement portion of the fourth adapter is provided at the side opposite to the side of the fifth adapter,
the engagement portion of the seventh adapter is provided at the side opposite to the side of the eighth adapter, and
the engagement portion of the tenth adapter is provided at the side opposite to the side of the eleventh adapter.

5. The optical switching unit according to claim 1, further comprising:
a first operation unit configured to be disposed in the first region;
a second operation unit configured to be disposed in the second region;
a third operation unit configured to be disposed in the third region; and
a fourth operation unit configured to be disposed in the fourth region,
wherein, when the first operation unit is operated, the first optical switch switches optical connection of the first and second adapters and optical connection of the first and third adapters,
when the second operation unit is operated, the second optical switch switches optical connection of the fourth and fifth adapters and optical connection of the fourth and sixth adapters,
when the third operation unit is operated, the third optical switch switches optical connection of the seventh and eighth adapters and optical connection of the seventh and ninth adapters, and
when the fourth operation unit is operated, the fourth optical switch switches optical connection of the tenth and eleventh adapters and optical connection of the tenth and twelfth adapters.

6. The optical switching unit according to claim 5, wherein
the first operation unit is disposed closer to the side of the second region than the first to third adapters,
the second operation unit is disposed closer to the side of the first region than the fourth to sixth adapters,
the third operation unit is disposed closer to the side of the fourth region than the seventh to ninth adapters, and
the fourth operation unit is disposed closer to the side of the third region than the tenth to twelfth adapters.

7. The optical switching unit according to claim 1, further comprising:
a first display configured to show an adapter optically connected to the first adapter in the first optical switch, in the second and third adapters;
a second display configured to show an adapter optically connected to the fourth adapter in the second optical switch, in the fifth and sixth adapters;
a third display configured to show an adapter optically connected to the seventh adapter in the third optical switch, in the eighth and ninth adapters; and
a fourth display configured to show an adapter optically connected to the tenth adapter in the fourth optical switch, in the eleventh and twelfth adapters,
wherein the first display is disposed in the first region,
the second display is disposed in the second region,
the third display is disposed in the third region, and
the fourth display is disposed in the fourth region.

8. The optical switching unit according to claim 7, wherein
the first display is disposed closer to the side of the second region than the first to third adapters,
the second display is disposed closer to the side of the first region than the fourth to sixth adapters,
the third display is disposed closer to the side of the fourth region than the seventh to ninth adapters, and
the fourth display is disposed closer to the side of the third region than the tenth to twelfth adapters.

9. The optical switching unit according to claim 1, further comprising:
a first light reception element configured to detect strength of an optical signal input to or output from the second adapter;
a second light reception element configured to detect strength of an optical signal input to or output from the third adapter;
a third light reception element configured to detect strength of an optical signal input to or output from the fifth adapter;
a fourth light reception element configured to detect strength of an optical signal input to or output from the sixth adapter;
a fifth light reception element configured to detect strength of an optical signal input to or output from the eighth adapter;
a sixth light reception element configured to detect strength of an optical signal input to or output from the ninth adapter;
a seventh light reception element configured to detect strength of an optical signal input to or output from the eleventh adapter; and
an eighth light reception element configured to detect strength of an optical signal input to or output from the twelfth adapter.

10. The optical switching unit according to claim 1, wherein
the first to twelfth adapters are adapters for LC connectors.

11. An optical switching device comprising:
the optical switching unit according to claim 1; and
a frame configured to mount one or more optical switching units.
